(19) United States
(12) Patent Application Publication
(10) Pub. No.: US 2015/0124843 A1
(43) Pub. Date: May 7, 2015

(54) SHORTENED TRAINING FIELD PREAMBLE STRUCTURE FOR HIGH EFFICIENCY WI-FI ENVIRONMENT

(71) Applicants: Shahrnaz Azizi, Cupertino, CA (US); Thomas J. Kenney, Portland, OR (US); Eldad Perahia, Portland, OR (US)

(72) Inventors: Shahrnaz Azizi, Cupertino, CA (US); Thomas J. Kenney, Portland, OR (US); Eldad Perahia, Portland, OR (US)

(21) Appl. No.: 14/127,284

(22) PCT Filed: Nov. 4, 2013
(86) PCT No.: PCT/US13/68312

§ 371 Date: Dec. 18, 2013

(51) Int. Cl. H04L 7/00; H04L 7/04

(52) U.S. Cl. CPC H04L 7/0016; H04L 7/04
USPC 370/516

(57) ABSTRACT

The disclosure generally relates to a shortened training field preamble structure for high-efficiency Wi-Fi environments. In one embodiment, the disclosure relates to a communication system having a transmitter transmitting a Master-Sync packet received by stationary and mobile receivers. The Master-Sync packet contains information for communicating in a HEW environment. Upon receipt each receiver decodes the Master-Sync packet to (i) estimate a frequency offset and/or an automatic gain control (AGC) setting; (ii) select a transmission frequency consistent with the frequency offset; and/or (iii) determine a new transmission power consistent with the AGC; (iv) tune to a new frequency offset and gain control setting to receive subsequent packets from the transmitter.

This application claims priority to the filing date PCT/US2013/068312, filed Nov. 4, 2013, the specification of which is incorporated herein in its entirety.

### BACKGROUND

1. Field

The disclosure relates to a method and apparatus for communicating in a high-efficiency Wi-Fi environment. Specifically, the disclosure relates to shortening the preamble of data packets used, among others, during scheduled or short exchanges.

2. Description of Related Art

The increasing use of mobile devices has placed significant strain on the available public and private networks. High-traffic areas such as airports, transit stations, educational and hospital campuses, stadiums and other professional or entertainment venues provide internet access, typically through one or more wireless local area network (WLAN). During such communications an Access Point (AP) must communicate with wireless stations (STAs). With the wireless network demand on the rise, these WLANs struggle to maintain viable wireless access. Many such environments include heterogeneous networks of WLANs which coexist, and often interfere, with each other. Accordingly, there is a need for a high-efficiency Wi-Fi environment (HEW) that enables efficient cohabitation of heterogeneous WLANs.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 illustrates an exemplary HEW network;

FIG. 2 shows a conventional packet structure under the Legacy standard;

FIG. 3 illustrates a data packet structure under the Legacy standard;

FIG. 4 is an exemplary packet for communication in the HEW environment;

FIG. 5 shows an exemplary HEW environment for implementing abbreviated packets;

FIG. 6 is a flow-diagram for implementing an embodiment of the disclosure;

FIG. 7 illustrates an exemplary device for implementing an embodiment of the disclosure; and

FIG. 8 is an exemplary system for implementing an embodiment of the disclosure.

### DETAILED DESCRIPTION

The disclosed embodiments are generally directed to a method and apparatus for efficient use of the communication medium in a high-density environment. More specifically, the disclosed embodiments provide method and apparatus for effective bandwidth utilization in dense cellular environment by using a shortened packet preamble for downlink communications.

A dense cellular environment is one in which many communication nodes and/or devices compete for access to the communication medium. For example, shopping malls, university residence halls or stadiums all have a multitude of nodes and/or network devices contending for access to the same communication channel. Given the bandwidth limitations and the ever-increasing cellular density, there is a need for high efficiency Wi-Fi communication techniques.

An exemplary embodiment of the disclosure provides a shortened preamble used during a scheduled or queried exchanges. The shortened preamble can be in the form of a Master-Sync information packet (interchangeably, Master-Sync packet) which is broadcasted by the Access Providers (AP) during regular intervals. Exemplary APs includes routers, repeaters, central transmitter nodes and base stations. By shortening the packet preamble as described below, significant efficiency can be gained in a dense network's downlink and uplink communications.

Because of the increased usage of mobile devices, most WLANs are serving high density STAs. The uses include high rate video transmission requiring much of the system's resources and other high bandwidth demands. Whereas the conventional wireless protocols (i.e., the Institute of Electrical and Electronics Engineers (IEEE) legacy 802.11 standards, such 802.11ac/ah) mainly focus on increased data rate and raw peak data, the HEW usage requires overall system efficiency. In high-density hot-spot scenarios, many devices compete for the medium with low to moderate data rate requirements. To this end, embodiments generally aim to improve system efficiency such as for use in HEW environments.

As discussed, an embodiment of the disclosure is directed to providing shortened training field preamble structure for use in a HEW environment where one or more APs service one or more STAs. Each AP can be managed by a controller jointly or independently of other APs. In the exemplary HEW environment, an AP contends for access and control of the communication medium. Once obtained, a dedicated length of time (allotted time) is granted to the AP. The allotted time can be, for example, 10 msec. every minute. During the allotted time, the AP may transmit downlink data in the form of a Master-Sync packet to all corresponding or associated STAs. The communication may also be to a selected few STAs. The synchronization information may be contained in the header or the payload of the Master-Sync information packet. The Master-Sync information packets may be recombined as frames prior to transmission. The STAs may use information contained in the Master-Sync packet for subsequent communication with the AP. The STAs may also use a portion of the allotted time (as scheduled by the AP in the Master-Sync packet) to communicate with the AP in the uplink.

The Master-Sync information packet may contain frequency, power and other information necessary to efficiently communicate in the HEW environment. For example, the Master-Sync information packet may include information enabling STAs to select a new frequency offset correction value for receiving subsequent data packets from the AP. The Master-Sync packet may also include information enabling STAs to determine new gain values for different stages of the Automatic Gain Control (AGC) for receiving subsequent data packets or for uplink transmission. The frequency offset correction value provides the shift from the ideal frequency to reduce interference. The AGC helps the STAs determine signal gain.

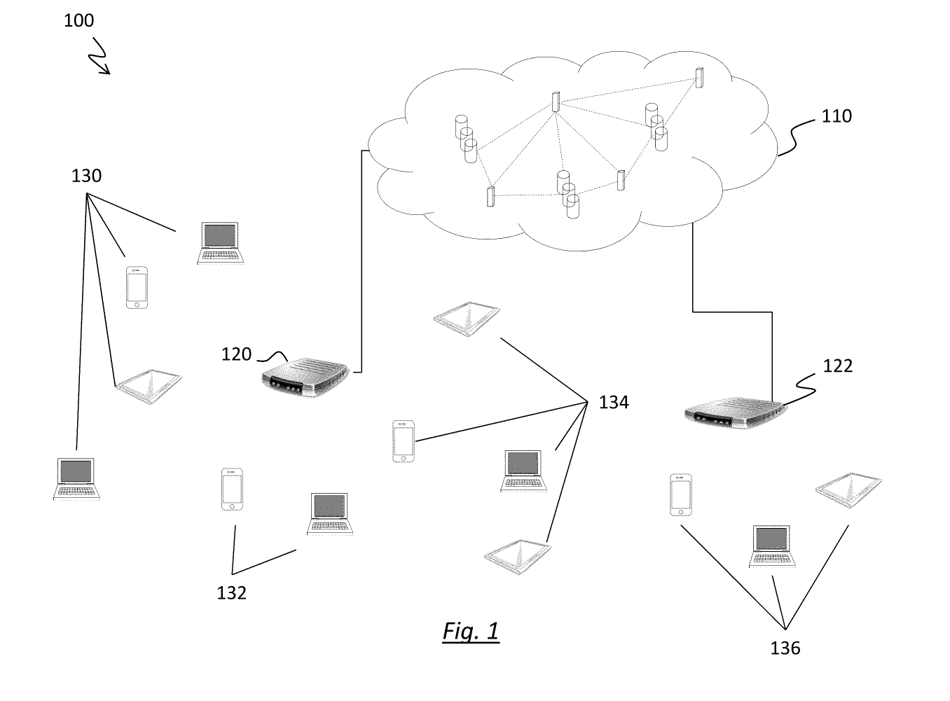

FIG. 1 illustrates an exemplary HEW network. Specifically, FIG. 1 shows HEW environment 100 having network 110 communicating with access points 120, 122. While FIG. 1 shows APs 120 and 122 as part of network 110, the disclosed principles are not limited thereto and are equally applicable to environments where the AP is outside the network. Exemplary STAs include smartphones, laptops and tablets or any other wireless device. STAs 130, 132, 134 and 136 can communicate with either of the APs (or masters) 120, 122. As briefly discussed above, each of APs 120, 122 can define a different WLAN and may comprise a modem, a router or any other circuitry having a processor circuit in communication with a memory circuit adapted to compete for medium and deliver wireless access. APs 120 and 122 may compete with each other and with other devices for the medium.

According to one embodiment of the disclosure, each AP may send out one or more transmission signals after it has contended for, and gained, access to the communication medium. The transmission signal can include Master-Sync information packets, for example, in the Request to Send (RTS) or Clear to Send (CTS) frames or other scheduling frame transmissions. The STAs can use the Master-Sync information to synchronize with the respective AP. In one embodiment, the transmission includes a schedule for each HEW STA to know the time it will have access to the channel during the allotted time the master AP has control of the channel. During this time each STA may uplink transmit to the master. The uplink transmission can occur during a portion of the allotted time. Hence, after completion of the master's transmission, all STAs can be synchronized to their respective masters and partake in uplink communication with the master AP. As stated, the Master-Sync packet can also be used to converge each STA's AGC to an appropriate receive level.

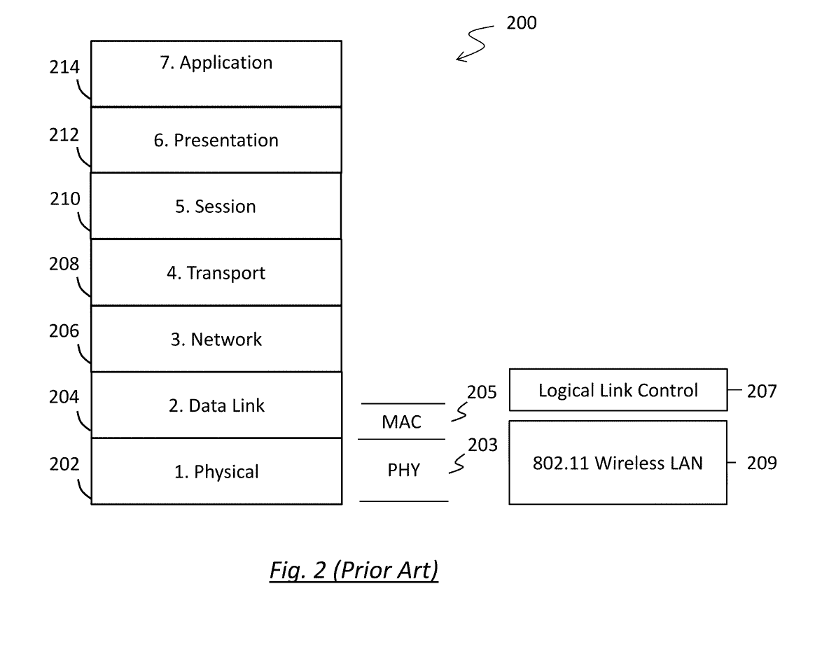

FIG. 2 shows the IEEE OSI architecture model for the standard 802.11 protocol. The model includes layers 1-7, corresponding to the Physical Layer 202, Data Link Layer 204, Network Layer 206, Transport Layer 208, Session Layer 210, Presentation Layer 212 and Application Layer 214. The Data Link layer includes two sub-layers: Logical Link Control (LLC) 207 and Media Access Control (MAC) 205. All of the components in the legacy OSI architecture fall into either the MAC sublayer or the Physical Layer.

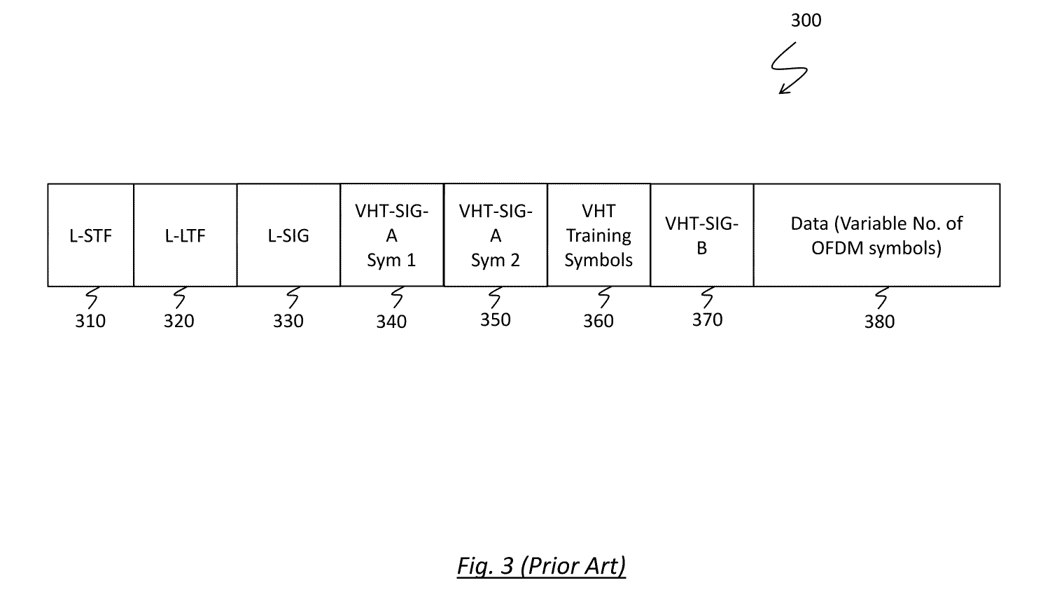

FIG. 3 illustrates a data packet structure under the legacy standard. Packet 300 includes Legacy Short Training Field (L-STF) 310, Legacy Long Training Field (L-LTF) 320, Legacy Signal field (L-SIG) 330, Very- High-Throughput (VHT) SIG-A-Sym-1 field, 340, VHT SIG-A-Sym-2 field 350, VHT training symbols 360, VHT-SIG-B 370 and data field 380.

L-STF 310 consists of ten repetitions of the so-called Short Training Sequence (STS). The repetitive pattern of STS is used by the receiver for several critical mechanisms for signal detection and acquisition. L-STF 320 is typically used for start of packet detection, Automatic Gain Control (AGC) settling, coarse frequency offset estimation and symbol timing or boundary timing. The exact details of these functions vary based on implementation.

L-LTF 320 uses two repetitions of the Long Training Sequence (LTS) along with a guard interval. The L-LTF is used for fine frequency and timing offset estimation in addition to channel estimation. The L-LTF is distinct from (non-Legacy) VHT Training fields.

As with L-STF 310, approaches and uses are implementation-dependent. At the end of the L-LTF, the device should have the AGC settled, the frequency and timing offset set to an acceptable level and be able to effectively demodulate the data portion. A channel estimate must also be attained prior to demodulation. The combination of L-STF and L-LTF consume significant overhead particularly affecting the dense deployment in HEW environment.

According to one embodiment of the disclosure, a new packet header is configured which is shortened or abbreviated as compared with the legacy packet header. By way of example, an abbreviated packet header may have only a single LTS, entirely exclude STF, have nulled bits in the LTS portion(s) or a combination thereof. The length of the guard bits may also be reduced to abbreviate the packet header. For example, the guard bits can be reduced to half, a third or less to shorten the packet header.

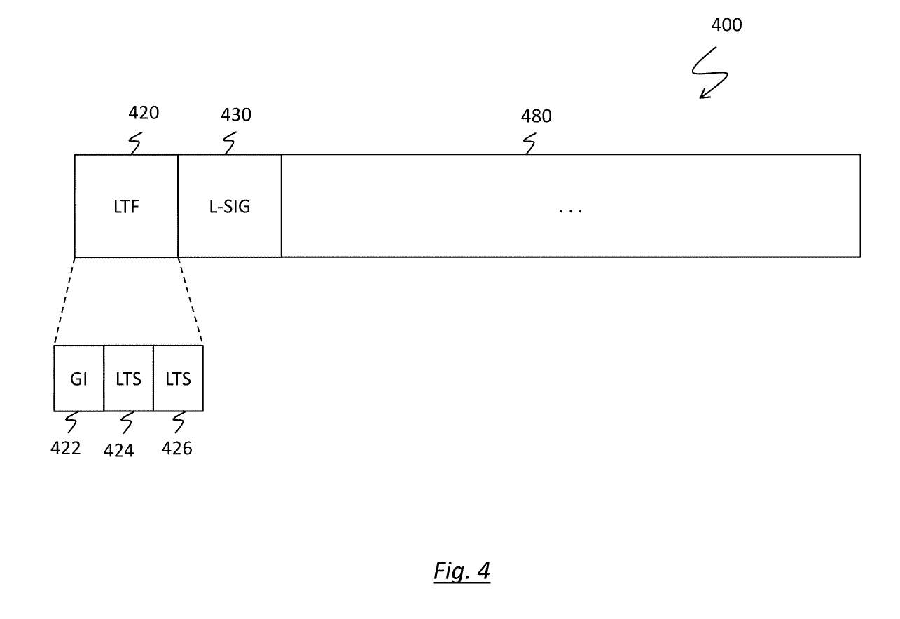

FIG. 4 is an exemplary packet structure for communication in the HEW environment. Packet 400 includes LTF 420, L-SIG 430 and remaining portion 480. L-SIG 430 may contain similar content as L-SIG 306 (FIG. 3). Portion 480 may define the data portion or may include additional Legacy header information (e.g., VHT-SIG-A Sym 1, etc.).

Packet 400 is shorter than packet 300 (FIG. 3) as, among others, it excludes L-STF 310. As detailed below, Packet 400 also contains a significantly shorter LTF 420. In the HEW environment, the MAC layer (FIG. 2) of the master devices provides an initial Master-Sync packet transmission that all STAs will detect and decode to thereby synchronize to the master. Through synchronization, the AGC can be settled and there would be no need to do the start of packet detection or contend for the medium at each STA. Also, through synchronization the STAs learn when they are scheduled next to receive or transmit packets. Subsequent downlink transmission may also include Master-Sync information packets for routine synchronization.

Further, the frequency offset is estimated from the initial Master-Sync information packet. This obviates the need for L-STF (FIG. 3) which was also used to provide the same function in the Legacy packets. Since in the HEW scheduling duration the time that the master holds the medium will be finite (e.g., 10 msec.), there may be some drift from the moment the master (or initial Master-Sync) transmission signal is sent until the moment the master later services the STA. Therefore, the ability to perform fine frequency offset estimation and correction is required for subsequent received packets.

A frequency offset value can be determined from the LTS sequences of the L-LTF. Removing one of the two LTS sequences requires modifying the remaining LTS. In one embodiment of the disclosure, fine frequency offset is derived by nulling tones in the Legacy LTS. For example, the nulling can be every other value in the sequence which results in an LTS having alternating zeros with a repeated structure in time domain. The repetition in time domain also provides an accurate symbol boundary. It should be noted that the disclosed principles are not limited to nulling every other value. For example, nulling can be implemented more frequently than every other value to include, for example, two nulls followed by a value followed again by two nulls and a value. This can be expanded to include more frequent nulling.

The exemplary embodiment of FIG. 4 shows one LTF having two LTS's. Nulling every other subcarrier provides repeated structure in time. Hence, each of the two LTSs will have half a duration in time compared to the original LTS. The preamble of FIG. 4 increases the Physical Layer's efficiency for the HEW environment. Again, it should be noted that the embodiment of FIG. 4 is exemplary and different techniques and combinations can be used to form an abbreviated header/packet. For example, one or more technique disclosed herein can be used to abbreviate the header.

The Legacy improvements focused on higher data rate to accommodate high-demand applications such as video streaming. In these applications, modifying the Physical Layer preamble would only provide marginal improvement. However, the preamble modification disclosed herein improves performance in the HEW environment by as much as 21% when there are dense deployments of STAs exchanging many short packets. In high-density environments where tens or hundreds of packets are exchanged each millisecond, the disclosed preamble reduces overhead thereby providing gain. As the payload is increased, the gain degrades.

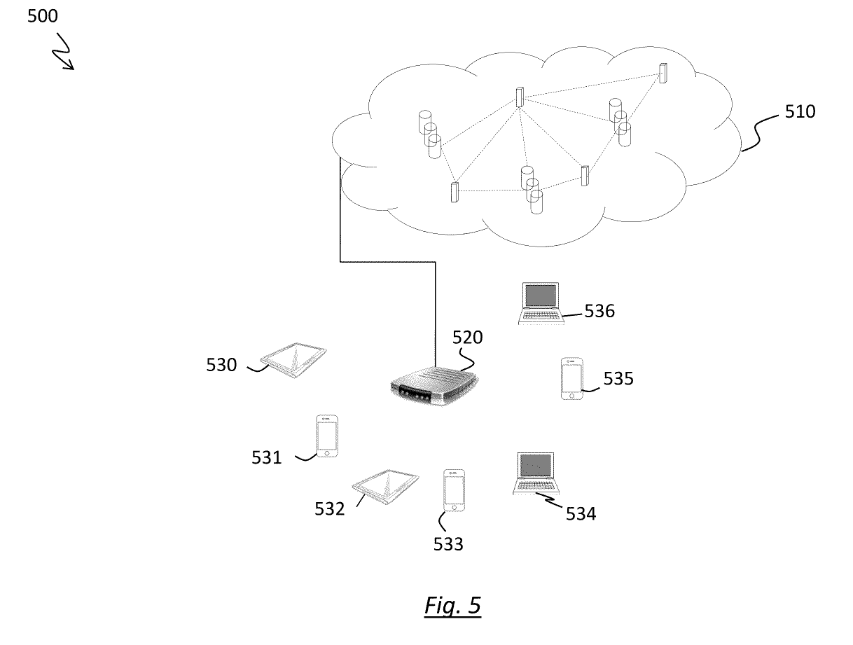

FIG. 5 shows an exemplary HEW environment for implementing the abbreviated packets according to one embodiment of the disclosure. Environment 500 includes AP 520 which acts as the master and communicates with STAs 530-536. For illustrative purposes, STAs include smartphones, laptops and tablets. AP 520 also communicates with the wireless network 510. AP 520 can be one of the multiple WLANs serving HEW environment 530.

In one embodiment, the STAs receive routine signals from AP 520. The routine signal may include a Master-Sync information packet or any other initial transmission identifying AP 520 to its corresponding STAs. The Master-Sync packet may be transmitted when AP 520 has contended and obtained control of the transmission channel. Each STA receiving the Master-Sync packet will then synchronize itself to AP 520 and have a time basis derived from Master-Sync packet. The Master-Sync packet may include a schedule for each STA to access the channel. That is, the Master-Sync packet may identify when each STA may access the medium during the time the master has control of the medium. The STAs can also use the Master-Sync packet to converge on the appropriate AGC. Thus, each STA will know its subsequent scheduled channel access (i.e., uplink transmission) as well as its required transmission power.

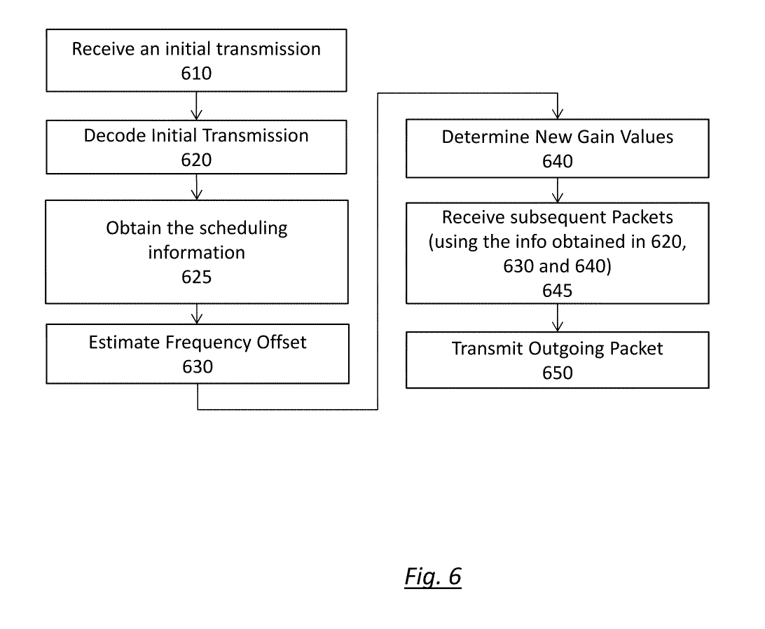

FIG. 6 is a flow-diagram for implementing an embodiment of the disclosure. The flow-diagram of FIG. 6 starts when a master in a HEW environment sends an initial or a Master-Sync packet to each of its corresponding STAs. As will be discussed in greater detail, the master can comprise one or more processors (forming a processor circuit) in communication with one or more memory devices (forming a memory circuit). Similarly, the STA may include one or more processors in communication with one or more memory devices that store execution instructions for the processors.

At step 610 a STA receives the initial Master-Sync information packet from an AP. The initial Master-Sync packet is then decoded at step 620. At step 625, the scheduling information is obtained from the initial Master-Sync packet. The information may be contained in one or more packets with each packet having a header. At step 630, the STA selects a new frequency offset value for receiving subsequent packets from the AP. At step 640, the STA determines new gain values for different stages of AGC for subsequent packets. At step 645, the STA receives subsequent packets using the information obtained at the previous steps. The subsequent packet may also contain synchronization information in the form of a Master-Sync header. Finally, having selected the frequency offset value and the new gain values, the STA transmits outgoing (uplink) packets at step 650. The uplink packets may be transmitted during a portion of the AP's allotted time. Alternatively, the STA may use the frequency offset and gain values to receive subsequent Master-Sync packet form the AP.

The processes of FIG. 6 can be implemented at a system having one or more antennas. Each antenna can be configured for a different protocol. The antennas communicate with a radio which may include both a transmitter and a receiver. The radio can define the front-end portion of the system. A processor circuit or other processing devices can be in communication with the radio and a memory circuit. The memory circuit can include instructions for the processor to receive a Master-Sync information packet, determine a frequency offset correction value from the Master-Sync information packet and tune a wireless device according to the frequency offset correction value to receive a subsequent data packet with an abbreviated header. The described instructions may also be configured as a non-transitory machine- or computer-readable medium, or alternatively, programmed on a processor as firmware.

It should be noted that the method outlined in FIG. 6 is an exemplary and non-limiting embodiment of the disclosure. For example, the method may include an abbreviated packet that excludes only one of the Legacy LTS's. In another embodiment, the packet may exclude L-STF entirely but have repetitive LTFs.

In one embodiment of the disclosure, the STA forms one or more outgoing packets having an abbreviated header as disclosed herein. The abbreviated header may exclude the Legacy L-STF. The abbreviated header may be used to communicate with the AP or with other STAs. The abbreviated header may include a single, LTF (non-Legacy LTF) that has repeated structure in time domain by nulling every other tones of LTS in frequency domain. Guard bits may also be included in the header. In another embodiment of the disclosure, the AP forms one or more outgoing packets having an abbreviated header as disclosed herein. The abbreviated header may exclude the Legacy STF. The subsequent packets with abbreviated header can be used to transmit subsequent packets to STAs according to the scheduled information sent to STAs in the Master-Sync packet. In still another embodiment, the Master-Sync packet is decoded to obtain scheduling information for the subsequent data packets either received downlink or scheduled to be transmitted uplink. In addition, the time domain repeated structure of LTF is used to obtain symbol timing and boundary timing information for the subsequent data packets.

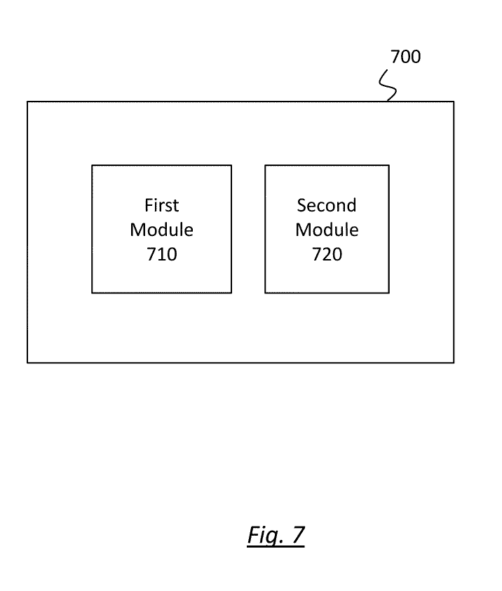

FIG. 7 illustrates an exemplary device for implementing an embodiment of the disclosure. Specifically, FIG. 7 shows device 700 having first module 710 and second module 720. Device 700 can be an integral part of a larger system or can be a stand-alone unit. For example, device 700 can define a system on chip configured to implement the disclosed methods. Modules 710 and 720 can be hardware, software or a combination of hardware and software. In an exemplary embodiment, at least one of modules 710 or 720 includes a processor circuit and a memory circuit communicating with each other. In another exemplary embodiment, device 700 may be an integrated processor configured with one or more modules to implement the disclosed embodiments. Further, device 700 may be part of a larger system having one or more antennas (not shown), a radio (not shown) and a memory system (not shown).

In an exemplary embodiment, device 700 may be a processor having modules 710 and 720. First module 710 can be configured to receive a Master-Sync information packet. The Master-Sync information packet can be an packet that provides the minimum information needed to obtain one or more of the frequency offset correction value and/or a gain value. Further, the subsequent data packets which follow the initial data packet may also contain Master-Sync information. The subsequent Master-Sync information enable continuous communication between the AP and STAs with reduced data overhead.

The Master-Sync information packet may be received at a radio (not shown) and relayed to Processor 700. Second module 720 can be configured to determine a frequency offset correction value from the Master-Sync information packet and to tune the radio according to the frequency offset correction value so as to receive a subsequent data packet. As discussed, the subsequent data packet may have an abbreviated header as described above. Second module 720 may be further configured to determine a gain value from the Master-Sync information packet and to adjust the Automatic Gain Control (AGC) of the radio according to the gain value.

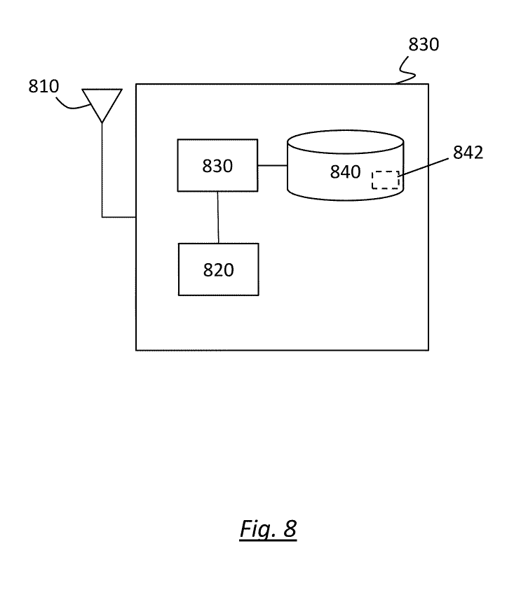

FIG. 8 is an exemplary system for implementing an embodiment of the disclosure. For example, the steps of flow-diagram of FIG. 6 may be implemented in the device of FIG. 8. System 800 of FIG. 8 may define an AP. While system 800 is shown with antenna 842, the disclosure is not limited to having one antenna. Multiple antennas can be added to system 800 such that different signals for different protocols can be received at different antennas. The signal(s) received at antenna 810 are relayed to radio 820. Radio 820 may include transceiver components such as front-end receiver components or a receiver/transmitter. Although not shown, system 800 may be connected to a WLAN or the internet backbone.

Radio 820 can communicate signal information, which may include Mastery-Sync information packet(s) to processor 830. Processor 830 may include one or more modules as discussed in relation to FIG. 7. Processor 830 also communicates with memory circuit 840. While shown as a separate circuitry in the exemplary system of FIG. 8, it should be noted that instructions 842 can be embedded on processor 830 as firmware to obviate the addition of memory circuit 840.

Memory circuit 840 may contain instructions for processor 830 to implement one or more of the steps of an exemplary method outlined above. Memory circuit 840 may define a non-transitory computer readable medium to direct processor 830 (or a module thereof) with instructions 842 to determine a frequency offset correction value from the Master-Sync information packet and to tune radio 820 according to the frequency offset correction value. Once tuned, radio 820 can receive the second data packet with an abbreviated packet header. Also, the information in the Master-Sync information packet can be used to direct radio 820 and antenna 810 to transmit uplink data at scheduled time. Memory circuit 840 may also instruct processor 830 (or a module thereof) to determine a gain value from the Master-Sync information packet and to adjust the Automatic Gain Control (AGC) of the radio according to the gain value.

Again, it should be noted the information in the Master-Sync information packet can be used to reduce the overhead in a HEW environment. To this end, one or more the outlined techniques can be used to reduce the information content of the packet header. For example, the packet header may provide the minimum information required for the STAs to determine the frequency offset correction value and/or to determine the appropriate gain value. The packet header may also provide uplink communication schedule for the STAs.

The following examples pertain to further embodiments of the disclosure. Example 1 is directed to 1 a wireless communication method comprising receiving a first signal at a wireless device, the first signal containing a Master-Sync information packet; determining a frequency offset correction value from the Master-Sync information packet; determining an Automatic Gain Control (AGC) value from the Master-Sync information packet; and tuning the wireless device according to the frequency offset correction value and adjusting the AGC according to the gain value; receiving a second signal, the second signal including a data packet with an abbreviated header.

Example 2 is directed to the method of example 1, wherein the abbreviated header comprises a single Long Training Sequence (LTS).

Example 3 is directed to the method of examples 1 or 2, wherein the abbreviated header comprises a plurality of guard bits followed by a plurality of nulled bits.

Example 4 is directed to the method of example 1, further comprising receiving the first signal at a High Efficiency Wi-Fi (HEW) environment.

Example 5 is directed to the method of any of examples 1-5, wherein the abbreviated header excludes a Legacy Short Training Field (L-STF).

Example 6 is directed to the method of example 1, wherein the abbreviated header defines an LTS where each alternative bit value is nulled.

Example 7 is directed to the method of example 1, further comprising decoding the Master-Sync information packet at an STA to determine when to access the medium.

Example 8 is directed to the method of example 1, further comprising decoding the Master-Sync information packet to determine a schedule for receiving uplink communication from one or more wireless devices.

Example 9 is directed to the method of example 1, further comprising decoding the Master-Sync packet to obtain a symbol timing and a boundary timing for the second signal.

Example 10 is directed to a device comprising: a first module configured to receive a Master-Sync information packet and a subsequent data packet with an abbreviated header; a second module configured to determine a frequency offset correction value from the Master-Sync information packet and to tune a wireless device according to the frequency offset correction value so as to receive the subsequent data packet.

Example 11 is directed to the device of example 10, wherein the second module is further configured to determine a gain value from the Master-Sync information packet and to adjust the Automatic Gain Control (AGC) of the wireless device according to the gain value.

Example 12 is directed to the device of example 10, further comprising a third module configured to determine a gain value from the Master-Sync information packet and to adjust the Automatic Gain Control (AGC) of the wireless device according to the gain value.

Example 13 is directed to the device of any of examples 10-12, wherein the abbreviated header comprises a single Long Training Sequence (LTS).

Example 14 is directed to the device of any of examples 10-12, wherein the abbreviated header defines an LTS in which a number of bit values are nulled.

Example 15 is directed to the device of any of examples 10-12, wherein the abbreviated header defines an LTS where each alternative bit value is nulled.

Example 16 is directed to the device of any of examples 10-12, wherein the second module is further configured to decode the Master-Sync information packet to obtain a symbol timing and a boundary timing for the subsequent data packet.

Example 17 is directed to a communication system, comprising: one or more antennas; a radio communicating with the one or more antennas, the radio configured to receive a Master-Sync information packet and a subsequent data packet, the subsequent data packet having an abbreviated header; a processor having a first module configured to determine a frequency offset correction value from the Master-Sync information packet and to tune the radio according to the frequency offset correction value so as to receive the subsequent data packet.

Example 18 is directed to the system of example 17, wherein the processor further comprises a second module configured to determine a gain value from the Master-Sync information packet and to adjust the Automatic Gain Control (AGC) of the radio according to the gain value.

Example 19 is directed to the system of examples 17 or 18, wherein the subsequent data packet with an abbreviated header comprises a plurality of guard bits followed by a plurality of nulled bits.

Example 20 is directed to the system of example 17 or 18, wherein the abbreviated header defines an LTS where each alternative bit value is nulled.

Example 21 is directed to the system of example 17 or 18, wherein the abbreviated header further comprises a single Long Training Sequence (LTS).

Example 22 is directed to the system of example 17 or 18, wherein the Master-Sync information packet further comprises a schedule for receiving uplink communication from one or more wireless devices.

Example 23 is directed to a non-transitory computer-readable medium with an executable program stored thereon, wherein the program instructs a processor to determine a frequency offset correction value from the Master-Sync information packet and tune a wireless device according to the frequency offset correction value to receive a subsequent data packet with an abbreviated header.

Example 24 is directed to the non-transitory computer-readable medium of example 22, wherein the executable program further instructs the processor to determine a gain value from the Master-Sync information packet and adjusting the Automatic Gain Control (AGC) of the wireless device according to the gain value.

Example 25 is directed to the non-transitory computer-readable medium of example 22, wherein the executable program further instructs the processor to determine an uplink schedule from the Master-Sync information packet.

While the principles of the disclosure have been illustrated in relation to the exemplary embodiments shown herein, the principles of the disclosure are not limited thereto and include any modification, variation or permutation thereof.

1-25. (canceled)

26. A wireless communication method comprising:
receiving a first signal at a wireless device, the first signal containing a Master-Sync information packet;
determining a frequency offset correction value from the Master-Sync information packet;
determining an Automatic Gain Control (AGC) value from the Master-Sync information packet; and
tuning the wireless device according to the frequency offset correction value and adjusting the AGC according to the gain value;
receiving a second signal, the second signal including a data packet with an abbreviated header.

27. The method of claim 26, wherein the abbreviated header comprises a single Long Training Sequence (LTS).

28. The method of claim 26, wherein the abbreviated header comprises a plurality of guard bits followed by a plurality of nulled bits.

29. The method of claim 26, further comprising receiving the first signal at a High Efficiency Wi-Fi (HEW) environment.

30. The method of claim 26, wherein the abbreviated header excludes a Legacy Short Training Field (L-STF).

31. The method of claim 26, wherein the abbreviated header defines an LTS where each alternative bit value is nulled.

32. The method of claim 26, further comprising decoding the Master-Sync information packet at an STA to determine when to access the medium.

33. The method of claim 26, further comprising decoding the Master-Sync information packet to determine a schedule for receiving uplink communication from one or more wireless devices.

34. The method of claim 26, further comprising decoding the Master-Sync information packet to obtain a symbol timing and a boundary timing for the second signal.

35. A device comprising:
a first module configured to receive a Master-Sync information packet and a subsequent data packet with an abbreviated header;
a second module configured to determine a frequency offset correction value from the Master-Sync information packet and to tune a wireless device according to the frequency offset correction value so as to receive the subsequent data packet.

36. The device of claim 35, wherein the second module is further configured to determine a gain value from the Master-Sync information packet and to adjust the Automatic Gain Control (AGC) of the wireless device according to the gain value.

37. The device of claim 35, further comprising a third module configured to determine a gain value from the Master-Sync information packet and to adjust the Automatic Gain Control (AGC) of the wireless device according to the gain value.

38. The device of claim 35, wherein the abbreviated header comprises a single Long Training Sequence (LTS).

39. The device of claim 35, wherein the abbreviated header defines an LTS in which a number of bit values are nulled.

40. The device of claim 35, wherein the abbreviated header defines an LTS where each alternative bit value is nulled.

41. The device of claim 35, wherein the second module is further configured to decode the Master-Sync information packet to obtain a symbol timing and a boundary timing for the subsequent data packet.

42. A communication system, comprising:
one or more antennas;
a radio communicating with the one or more antennas, the radio configured to receive a Master-Sync information packet and a subsequent data packet, the subsequent data packet having an abbreviated header;
a processor having a first module configured to determine a frequency offset correction value from the Master-Sync information packet and to tune the radio according to the frequency offset correction value so as to receive the subsequent data packet.

43. The system of claim 42, wherein the processor further comprises a second module configured to determine a gain value from the Master-Sync information packet and to adjust the Automatic Gain Control (AGC) of the radio according to the gain value.

44. The system of claim 42, wherein the subsequent data packet with an abbreviated header comprises a plurality of guard bits followed by a plurality of nulled bits.

45. The system of claim 42, wherein the abbreviated header defines an LTS where each alternative bit value is nulled.

46. The system of claim 42, wherein the abbreviated header further comprises a single Long Training Sequence (LTS).

47. The system of claim 42, wherein the Master-Sync information packet further comprises a schedule for receiving uplink communication from one or more wireless devices.

48. A non-transitory computer-readable medium with an executable program stored thereon, wherein the program instructs a processor to determine a frequency offset correction value from the Master-Sync information packet and tune a wireless device according to the frequency offset correction value to receive a subsequent data packet with an abbreviated header.

49. The non-transitory computer-readable medium of claim 47, wherein the executable program further instructs the processor to determine a gain value from the Master-Sync information packet and adjusting the Automatic Gain Control (AGC) of the wireless device according to the gain value.

50. The non-transitory computer-readable medium of claim 47, wherein the executable program further instructs the processor to determine an uplink schedule from the Master-Sync information packet.
